(19) United States
(12) Patent Application Publication
(10) Pub. No.: US 2006/0030961 A1
(43) Pub. Date: Feb. 9, 2006

(54) Wireless streaming audio apparatus

(76) Inventor: Jeng-Tay Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/912,135

(22) Filed: Aug. 6, 2004

(51) Int. Cl. G06F 17/00

(52) U.S. Cl. 700/94; 709/232; 709/231

(57) ABSTRACT

A wireless streaming audio apparatus receives a streaming compressed audio file from a wireless streaming server through a wireless network and plays back the streaming compressed audio file. The wireless streaming audio apparatus has a streaming and decompressing controller, an antenna, and an audio output. The streaming and decompressing controller receives the streaming compressed audio file through the antenna, decompresses the streaming compressed audio file and plays back the streaming compressed audio file through the audio output. The user receives a content table from the wireless streaming server and makes a selection. The wireless streaming audio apparatus then receives a play list from the wireless streaming server. Therefore user can listen to an unlimited amount of music from the wireless streaming server without being restricted by memory size.

### BACKGROUND OF THE INVENTION

1. Field of the Invention

The present invention relates to a wireless streaming audio apparatus, and more particularly, to a memory-free audio apparatus for playing a streaming audio file in wireless way.

2. Description of Prior Art

With the fast development of digital audio compression techniques and non-volatile memory, portable MP3 players employing flash memory as a storage medium are becoming increasingly popular. Portable MP3 players are developed to have other functions, like sound recording, FM radio and language learning, in addition to MP3 function and thumb driver function.

FIG. 1 shows a block diagram of a prior art portable MP3 player 10, which mainly comprises a controller 100, a data storage 102, an operation interface 104 and an audio output 106. The controller 100 receives user command input from the operation interface 104 and accesses an MP3 audio file stored in the data storage 102. The MP3 audio file is generally a compressed file to save storage space. The controller 100 fetches the MP3 audio file stored in the data storage 102 and then decompresses the same into an audible music file. The audible music file is played over an earphone set (not shown) or a loudspeaker (not shown) connected to the audio output 106.

However, the above-mentioned portable MP3 player suffers several problems. First, the playable audio content is limited by the storage size of the portable MP3 player. Until the summer of 2004, the commercially available MP3 player with flash memory has been limited to 128 MB or 256 MB of storage space. Even if the music file is compressed, the playable time of stored music is generally limited to 12-24 hours. Therefore, a user needs to frequently change the content in the flash memory through a USB cord. Alternatively, the portable MP3 player 10 such as Apple iPod can also use a mini hard disk. However, the price is this kind of portable MP3 player is very high. Second, the prior art portable MP3 player needs to store audio file in the memory thereof, and the issue of copyright limits the accessible music.

### SUMMARY OF THE INVENTION

It is an object of the present invention to provide an audio apparatus for playing a streaming audio file without using a memory.

It is another object of the present invention to provide an audio apparatus for playing a streaming audio file in wireless manner.

To achieve the above objects, the present invention provides a wireless streaming audio apparatus receiving a streaming compressed audio file from a wireless streaming server through a wireless network and playing back the streaming compressed audio file. The wireless streaming audio apparatus includes a streaming and decompressing controller, an antenna and an audio output. The streaming and decompressing controller receives the streaming compressed audio file through the antenna, decompresses the streaming compressed audio file and plays back the streaming compressed audio file through the audio output. The user can receive a table of contents from the wireless streaming server and make a selection. The wireless streaming audio apparatus then receives a play list from the wireless streaming server. Therefore, user can listen to an unlimited amount of music from the wireless streaming server without the restriction of memory size.

In above-mentioned description, the streaming compressed file can be a Real Audio file, a MS Media Player file, an Apple Quick Time file or other similar streaming compressed file. It should be noted that the streaming compressed file can be another type of streaming compressed file not listed above. The wireless streaming audio apparatus 20 can use a wireless protocol including GPRS, Wi-Fi, WiMax, or other similar protocols.

The above summaries are intended to illustrate exemplary embodiments of the invention, which will be best understood in conjunction with the detailed description to follow, and are not intended to limit the scope of the appended claims.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings, in which:

FIG. 1 shows a block diagram of a prior art portable MP3 player;

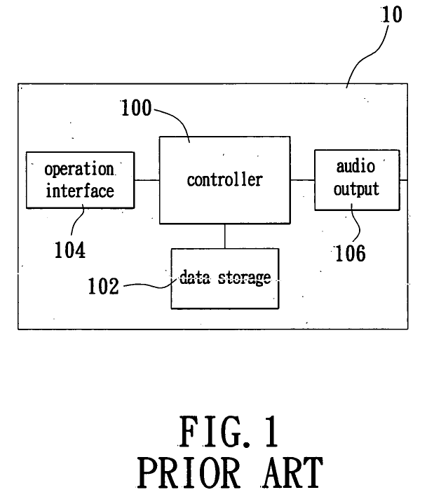

FIG. 2 shows the block diagram of the wireless streaming audio apparatus 20 according to the present invention; and

FIG. 3 shows a flowchart for operating the wireless streaming audio apparatus according to the present invention.

### DETAILED DESCRIPTION OF THE INVENTION

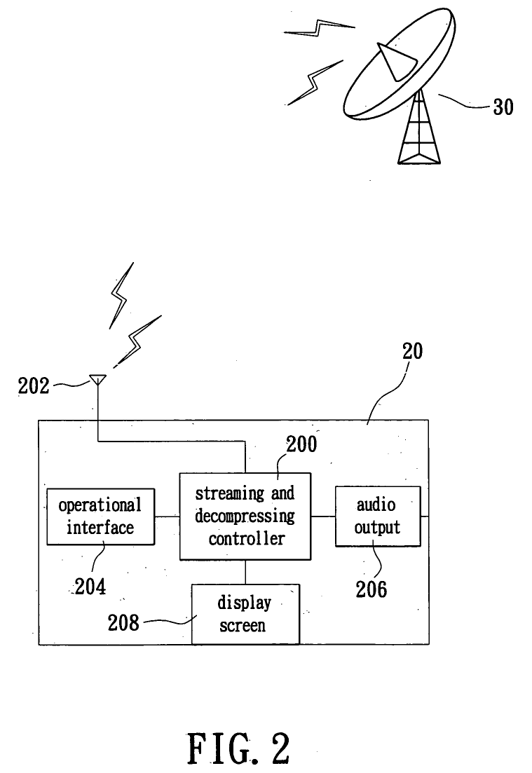

FIG. 2 shows the block diagram of the wireless streaming audio apparatus 20 according to the present invention. The wireless streaming audio apparatus 20 according to the present invention comprises a streaming and decompressing controller 200, an antenna 202, an operational interface 204, an audio output 206 and a display screen 208.

The wireless streaming audio apparatus 20 according to the present invention first receives a wireless signal containing a streaming audio file through the antenna 202 thereof. The received streaming audio file is a compressed audio file and stored in a built-in buffer of the wireless streaming audio apparatus 20. The streaming and decompressing controller 200 will play back the streaming audio file in real time after a delay time depending on the transmission bandwidth of wireless network and the size of the buffer. The streaming audio file is deciphered and decompressed by the streaming and decompressing controller 200 into an audible audio file. The audible audio file is played back over an earphone (not shown) or a loudspeaker (not shown) connected to the audio output 206.

The wireless streaming audio apparatus 20 according to the present invention receives a streaming compressed file through a wireless network and the streaming compressed file will not be stored in the wireless streaming audio apparatus 20. Therefore, the wireless streaming audio apparatus 20 according to the present invention does not raise copyright issues and does not need a memory (non-volatile or volatile).

The wireless streaming audio apparatus 20 according to the present invention uses the following steps to select playback content. After the wireless streaming audio apparatus 20 is turned on, the wireless streaming audio apparatus 20 is linked to a wireless streaming server 30 through a wireless network. The wireless streaming server 30 then sends a content table to the wireless streaming audio apparatus 20, and the content table is displayed on the display screen 208 of the wireless streaming audio apparatus 20. Therefore, a user can edit his user selection list by selecting his preferred songs and playing order. The selection list is sent to the wireless streaming server 30 and the wireless streaming server 30 will send back a play list to the wireless streaming audio apparatus 20 according to the user selection list and busy status thereof. The play list is displayed on the display screen 208 of the wireless streaming audio apparatus 20 so the user can know the play order and can delete songs at will.

In the above-mentioned description, the streaming compressed file can be a Real Audio file, a MS Media Player file, an Apple Quick Time file or other similar streaming compressed file. It should be noted that the streaming compressed file can be another type of streaming compressed file not listed above. The wireless streaming audio apparatus 20 can use a wireless protocol including GPRS, Wi-Fi, WiMax, or other similar protocols.

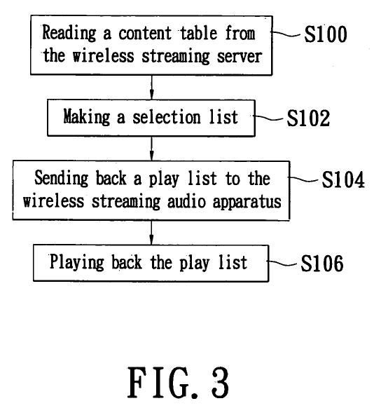

FIG. 3 shows a flowchart for operating the wireless streaming audio apparatus 20 according to the present invention, which comprises the following steps:

Step S100: The wireless streaming audio apparatus reads a content table from the wireless streaming server.

Step S102: The wireless streaming audio apparatus makes a selection list for played song and order.

Step S104: The wireless streaming server receives the selection list and sends back a play list to the wireless streaming audio apparatus.

Step S106: The wireless streaming audio apparatus receives a streaming audio file from the wireless streaming server receives according to the play list and plays back the streaming audio file in real time.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A wireless streaming audio apparatus receiving a streaming compressed audio file from a wireless streaming server through a wireless network and playing the streaming compressed audio file, the wireless streaming audio apparatus comprising:
a streaming and decompressing controller;
an antenna; and
an audio output;
wherein the streaming and decompressing controller receives the streaming compressed audio file through the antenna, decompresses the streaming compressed audio file and plays back the streaming compressed audio file through the audio output.

2. The wireless streaming audio apparatus as in claim 1, further comprising an operational interface and a display screen.

3. The wireless streaming audio apparatus as in claim 2, wherein the streaming and decompressing controller reads a content table from the wireless streaming server and displays the content table on the display screen.

4. The wireless streaming audio apparatus as in claim 3, wherein the streaming and decompressing controller sends a selection list to the wireless streaming server according to a user selection on the content table.

5. The wireless streaming audio apparatus as in claim 1, wherein the streaming and decompressing controller comprises a buffer for temporarily storing the streaming compressed audio file.

6. The wireless streaming audio apparatus as in claim 1, wherein the streaming compressed audio file is an MP3 file.

7. The wireless streaming audio apparatus as in claim 1, wherein the streaming compressed file is one of a Real Audio file, a MS Media Player file, an Apple Quick Time file and other similar streaming compressed file.

8. The wireless streaming audio apparatus as in claim 1, wherein the wireless streaming audio apparatus uses a wireless protocol including GPRS, Wi-Fi, WiMax, or other similar protocols.

9. A wireless streaming audio system, comprising:
a wireless streaming server sending a streaming compressed audio file through wireless transmission protocol;
a wireless streaming audio apparatus receiving the streaming compressed audio file from the wireless streaming server and playing back the streaming compressed audio file, the wireless streaming audio apparatus comprising:
a streaming and decompressing controller;
an antenna; and
an audio output;
wherein the streaming and decompressing controller receives the streaming compressed audio file through the antenna, decompresses the streaming compressed audio file and plays back the streaming compressed audio file through the audio output.

10. The wireless streaming audio system as in claim 9, further comprising an operational interface and a display screen.

11. The wireless streaming audio system as in claim 10, wherein the streaming and decompressing controller reads a content table from the wireless streaming server and displays the content table on the display screen.

12. The wireless streaming audio system as in claim 11, wherein the streaming and decompressing controller sends a selection list to the wireless streaming server according to a user selection on the content table.

13. The wireless streaming audio system as in claim 9, wherein the streaming and decompressing controller comprises a buffer for temporarily storing the streaming compressed audio file.

14. The wireless streaming audio system as in claim 9, wherein the streaming compressed audio file is an MP3 file.

15. The wireless streaming audio system as in claim 9, wherein the streaming compressed file is one of a Real Audio file, a MS Media Player file, an Apple Quick Time file and other similar streaming compressed file.

16. The wireless streaming audio system as in claim 9, wherein the wireless streaming audio apparatus uses a wireless protocol including GPRS, Wi-Fi, WiMax, or other similar protocols.
